(19) United States
(12) Patent Application Publication
(10) Pub. No.: US 2005/0228701 A1
(43) Pub. Date: Oct. 13, 2005

(54) Method for optimizing state guarantee fund coverage for insurance transactions

(76) Inventor: David A. Martin, Bentleyville, OH (US)

Correspondence Address: BROUSE MCDOWELL, 388 SOUTH MAIN STREET, SUITE 500, AKRON, OH, 44311-4407, US

(21) Appl. No.: 11/101,693

(22) Filed: Apr. 8, 2005

Related U.S. Application Data
(60) Provisional application No. 60/560,407, filed on Apr. 8, 2004.
(60) Provisional application No. 60/560,929, filed on Apr. 9, 2004.

(51) Int. Cl. G06F 17/60

(52) U.S. Cl. 705/4

(57) ABSTRACT

A new and improved method for optimizing state guarantee fund coverage for insurance transactions is herein disclosed. An insurance product includes at least two primary insurance policies written on a quota share basis, the policies having a combined coverage value, the percentage of the combined coverage value covered by each policy being between about 1% and about 99%. An insurance product includes a combined coverage value, wherein approximately 50% or more of the combined coverage value is protected by a jurisdictional guarantee association.

This application claims priority to provisional patent applications with Ser. No. 60/560,407, filed Apr. 8, 2004, titled Method For Optimizing Mixture Of Admitted-Carrier Coverage With Alternative-Risk-Transfer Methods In Order To Fully Access State Guarantee Fund Coverage For Insurance Transactions That Involve Alternative Risk Transfer Solution, and Ser. No. 60/560,929, filed Apr. 9, 2004, entitled Method For Layering Insurance Coverage Offered By Multiple Admitted Insurers In Order To Maximize State Guarantee Fund Coverage.

### I. BACKGROUND OF THE INVENTION

A. Field of the Invention

This invention relates to the art of insurance, and more particularly to optimizing state guarantee fund coverage for insurance transactions.

B. Description of the Related Art

The regulation of insurance company solvency is a function of each state and will continue to be so under the financial services reform law passed in 1999. Each state's insurance department monitors the financial health of insurers licensed to transact business in the state. For example, the Ohio Department of Insurance (ODI) is the state's regulator of insurance transactions.

To assist regulators in monitoring the financial condition of insurers, all licensed insurance companies file detailed annual financial statements with state insurance departments. The statements are uniform and each insurer writing business in the state is required to file.

The National Association of Insurance Commissioners (NAIC) has developed a series of tests—the Insurance Regulatory Information System (IRIS)—which facilitates the early identification of companies in financial trouble. Statistical data taken from these detailed statements are run through IRIS tests. If the tests indicate a company's financial ratios are outside the normal range in more than four areas, its finances are reviewed in greater detail to determine whether it is in need of immediate regulatory attention. In addition, insurance department examiners conduct periodic on-site audits of selected insurers each year, where all financial aspects of a company are reviewed in detail.

Unlike insurance guaranty associations, few other industries have a mechanism in place to provide a “safety net” for consumers of their product. Insurance providers are required to be members of a state's guaranty association as a condition of obtaining a license to write insurance in that state. The association operates through a board of directors composed largely of representatives of licensed insurers in the state. Its purpose is to reduce or avoid financial loss to policyholders and claimants resulting from the liquidation of an insolvent insurance provider.

The association, created by state law, provides a mechanism to collect and pool funds from solvent insurance providers to pay policyholder claims left unpaid as a result of the insurance provider's insolvency. When an insurance provider is declared insolvent, licensed insurance providers are assessed an amount based on their premium volume in that state. Each licensed insurance provider is required to pay their corresponding assessment to the guaranty association.

This insurance mechanism ensures payment (up to $300,000 in Ohio) to those policyholders, or on behalf of the policyholders, who have claims against the insolvent company. These could be typical insurance claims from damages caused by a covered peril under an insurance policy, or a claim against the insurance provider for unearned premiums.

In an effort to strengthen the methods used to measure an insurance provider's financial condition, the NAIC formally adopted solvency accreditation standards in June, 1990. All but two states have been accredited according to NAIC standards. The ODI was certified by the NAIC in December, 1991, the 9th state to receive accreditation.

Since its establishment in 1970, a total of ten Ohio Domestic P/C companies have been liquidated. Recent liquidations include LMI Insurance Company, liquidated in 2000, and PIE Mutual Insurance Company, liquidated in 1998. Prior to this, the most recent liquidations occurred in 1990.

The Ohio fund has assessed member companies over $265 million from 1970 through 2000. In 2000, the fund assessed $46.8 million, leaving $23.4 million in deferred assessments outstanding to be collected as needed to pay claims.

Numerous problems exist today in the insurance field, such as the following: 1) Medical Malpractice Insurance Premiums are skyrocketing in most states; 2) Medical Malpractice Insurers as an industry segment have experienced very poor results financially in recent years; 3) Many medical malpractice insurers have either failed financially, have had control seized by their domicile-state insurance department, or have chosen voluntarily to leave this segment of the market; 4) Other lines of insurance are experiencing similar trends; 5) Property insurers have faced significant financial challenges subsequent to Sep. 11, 2001 and related terrorist activities; 6) Increasing severity of liability claims has hit many insurers with large losses; 7) Asbestos claims, handgun manufacturer liability, mold claims, obesity/health claims against fast food restaurants—are just a few examples of market segments in which the insurance industry has experienced rapid growth in the dollar amounts of liability indemnity payments.

The following commercial and consumer reactions have taken place: 1) Risk Retention Groups and Captive Insurance Companies have been developed and licensed at a very fast rate of frequency in order to insure risks in markets or states where there is a) a shortage of capacity among the few insurers offering coverage terms; b) very few or no insurers offering coverage terms; c) insurers offering coverage at rates perceived to be unfair or too high by the person or entity being insured/buying/owning the insurance policy; and 2) Non-Admitted Insurers (“NAI”)/Excess and Surplus (“E&S”) Carriers have become more active in writing insurance in regions where there is a shortage of “capacity” among the “admitted carriers.” Non-admitted/E&S carriers are not covered by most state guarantee funds.

There are further problems as follows: 1) Risk Retention Groups (“RRG”), Captive Insurance Companies (“CIC”), Inter-Insurance Exchanges (“IIE”), Non-Admitted Insurers (“NAI”) and Excess and Surplus (“E&S”) carriers are not protected by most states “insurance guarantee funds/guarantee associations.” In the event that there is a failure of one of these RRGs, CICs, IIEs, NAIs or E&S carriers (or any other form of “unprotected insurer or insurance vehicle”), the beneficiary of the insurance policy loses all indemnification, benefit and value that was represented by the policy. If the insured party had been insured by an “admitted carrier” in their respective state/region/jurisdiction/territory, and that admitted carrier were to fail financially, then the insured party would continue to receive some level of indemnification from the “guarantee fund” or similar “vehicle” established to protect consumers in that particular area. In Ohio, for example, when PIE Mutual Insurance Company (a company that was “admitted” in Ohio and covered by Ohio's guarantee fund) was taken over by the Ohio Department of Insurance in December of 1997 for terrible financial performance, physicians who had been insured by PIE for their professional liability continued to enjoy indemnification from the guarantee fund in Ohio. Ohio's guarantee fund only indemnified the physicians for up to $300,000.00 per claim. Most of these physicians carried policy limits of $1,000,000.00 per claim. The guarantee fund only amounted to indemnification at 30% of their policy limits as written with PIE Mutual Insurance Company. 2) Hospitals typically require their medical staff members to carry minimum insurance limits of $1,000,000.00 per claim, in order to maintain admitting privileges at the hospital.

The present invention provides a new and improved method for optimizing insurance, and overcomes certain difficulties inherent in the related inventions while providing better overall results.

### II. Definitions

To assist the reader in understanding the description of this invention, the definitions of the following terms should be noted.
Admitted carrier—an insurance provider that is covered by a jurisdictional guarantee association.
Aggregate coverage amount—the total monetary value that an insurance provider will pay to, or on behalf of, a policyholder over the course of the term of the insurance policy.
Alien insurer—an insurance provider that has its principal place of business outside the United States and is not licensed in the particular jurisdiction of interest.
Captive insurance company—an insurance provider that is owned and/or controlled by an entity that is being insured.
Claims made insurance—Coverage for incidents that happen after the retroactive date, but prior to the expiration of a policy. The claim, however, must be reported to the insurance provider while a policy is in force.
Combined coverage value—collective total of multiple coverage values.
Coverage value—the total monetary value that an insurance provider will pay under the terms of a given policy to, or on behalf of, a policyholder for each incident.
Domestic insurer—an insurance provider that has its principal place of business in the United States and is licensed in the particular jurisdiction of interest.
Excess insurance policy—an insurance policy that provides coverage over and above the primary policy.
Foreign insurer—an insurance provider that has its principal place of business in the United States and is not licensed in the particular jurisdiction of interest.
Insurance jurisdiction—a region under the regulatory control of an insurance regulatory agency.
Insurance product—two or more insurance policies provided by one or more insurance carriers, providing coverage in the areas of property, casualty, health, workers compensation, disability, or any other line of insurance product, but specifically excluding life.
Jurisdictional guarantee association amount—the total monetary amount an insurance regulatory agency will pay to, or on behalf of, the policyholder if the policyholder's insurance provider becomes insolvent.
Loss Amount—the monetary value to restore the party suffering of a loss, in whole or in part, by payment, repair, or replacement.
Non-admitted carrier—an insurance provider that is not subject to the supervisory regulation of an insurance regulatory agency, at least in the particular jurisdiction of interest.
Occurrence policy—A policy providing liability coverage for incidents occurring during the policy period, regardless of when the claim is filed.
Primary insurance policy—The policy issued by the primary insurance provider; or the policy covering losses on a first-dollar basis; or the policy covering the first or bottom insurance layer in a layered program.
Property and casualty insurance—an insurance policy providing coverage for loss and/or damage to personal or real property, life, or person.
Reinsurance—(1) A contract of indemnity against liability by which the insurance provider procures another insurance to insure against loss or liability by reason of the original insurance; (2) Insurance by one insurance provider of all or part of a risk accepted by it with another insurance provider which agrees to reimburse the insurance provider for the portion of the claim insured.
Required Amount—an insurance coverage minimum imposed on an insured by a third party. The required amount is typically a condition precedent to certain privileges granted to the insured by the third party.
Run Off Provisions/Tail—This term has been used to describe both the exposure that exists after expiration of a policy and the coverage that may be purchased to cover that exposure. On a “claims made” form a tail coverage may be purchased to extend the period for reporting covered claims beyond the normal policy period.

### III. SUMMARY OF THE INVENTION

In accordance with one aspect of the present invention, an insurance product includes at least two primary insurance policies written on a quota share basis, the policies having a combined coverage value, the percentage of the combined coverage value covered by each policy being between about 1% and about 99%.

In accordance with another aspect of the present invention, the percentage of the coverage value covered by each policy being between about 25% and about 75%.

In accordance with another aspect of the present invention, the percentage of the coverage value covered by each policy is substantially equal.

In accordance with another aspect of the present invention, the at least two insurance policies are underwritten by at least two insurance companies.

In accordance with another aspect of the present invention, at least one of the at least two insurance companies are admitted carriers.

In accordance with another aspect of the present invention, the insurance product is chosen from the group comprising: a property insurance policy, a casualty insurance policy, a health insurance policy, a workers compensation insurance policy, and a disability insurance policy.

In accordance with another aspect of the present invention, the at least two primary insurance policies further comprises at least three primary insurance policies.

In accordance with another aspect of the present invention, the at least three primary insurance policies are underwritten by at least three insurance companies.

In accordance with another aspect of the present invention, at least two of the at least three insurance companies are admitted carriers.

In accordance with another aspect of the present invention, only the first of the admitted carriers to become insolvent would be covered by a jurisdictional guarantee association.

In accordance with another aspect of the present invention, approximately 50% or more of the combined coverage value is protected by a jurisdictional guarantee association.

In accordance with another aspect of the present invention, the insurance product is underwritten by an admitted carrier.

In accordance with another aspect of the present invention, the insurance product comprises at least two insurance policies.

In accordance with another aspect of the present invention, the insurance product is underwritten by at least two insurance companies, wherein at least one of the at least two insurance companies are admitted carriers.

In accordance with another aspect of the present invention, approximately % or more of the combined coverage value is protected by a jurisdictional guarantee association.

In accordance with another aspect of the present invention, approximately 75% or more of the combined coverage value is protected by a jurisdictional guarantee association.

In accordance with another aspect of the present invention, approximately 90% or more of the combined coverage value is protected by a jurisdictional guarantee association.

In accordance with another aspect of the present invention, the insurance product comprises at least three insurance policies.

In accordance with another aspect of the present invention, the product further comprises a provision wherein a claim is treated as distinct and separate for each insurance policy.

In accordance with another aspect of the present invention, the product further comprises a provision wherein claims may be consolidated within one of the policies, but may not be consolidated between multiple policies.

In accordance with another aspect of the present invention, the jurisdictional guarantee association amount coverage is approximately 50% or more of the mode of current policy amounts for all insureds in a given line of insurance within a given insurance jurisdiction.

In accordance with another aspect of the present invention, the jurisdictional guarantee association amount coverage is approximately 50% or more of the median of current policy amounts for all insureds in a given line of insurance within a given insurance jurisdiction.

In accordance with another aspect of the present invention, the jurisdictional guarantee association amount coverage is approximately 50% or more of the average of current policy amounts for all insureds in a given line of insurance within a given insurance jurisdiction.

In accordance with another aspect of the present invention, the insurance product has no reinsurance backing.

In accordance with another aspect of the present invention, the reinsurance backing is approximately 10% or less of coverage value.

In accordance with another aspect of the present invention, the reinsurance backing is approximately 50% or less of coverage value.

In accordance with another aspect of the present invention, a method of providing insurance includes the steps of providing an insurance product having a combined coverage value, wherein approximately 50% or more of the combined coverage value is protected by a jurisdictional guarantee association.

In accordance with another aspect of the present invention, the method further includes the step of providing coordinated claims management by one chosen from the group comprising: one of the at least two insurance companies and a managing general underwriter.

In accordance with another aspect of the present invention, the method further includes the step of providing coordinated underwriting by one chosen from the group comprising: one of the at least two insurance companies and a third party administrator.

In accordance with another aspect of the present invention, the method further includes the step of switching management of at least one claim to another of the carriers if the carrier managing the at least one claim becomes insolvent.

In accordance with another aspect of the present invention, an insurance product for insuring against failure of an admitted carrier, wherein the admitted carrier has provided a first insurance policy with a first coverage value greater than a jurisdictional guarantee association amount, the product comprising at least a second insurance policy, the at least a second policy having a second coverage value, the second coverage value being at least ½ of the difference between the first coverage value and the jurisdictional guarantee association amount, the at least a second policy containing a provision wherein the at least a second insurance policy only provides coverage if the admitted carrier becomes insolvent.

In accordance with another aspect of the present invention, the second coverage value is at least ⅔ of the difference between the first coverage value and the jurisdictional guarantee association amount.

In accordance with another aspect of the present invention, the second coverage value is at least the difference between the first coverage value and the jurisdictional guarantee association amount.

In accordance with another aspect of the present invention, the at least a second insurance policy is underwritten by an admitted carrier.

In accordance with another aspect of the present invention, the at least a second insurance policy further comprises at least a second and third insurance policies, wherein the at least a second and third insurance policies have a combined coverage value, the combined coverage value being at least ½ of the difference between the first coverage value and the jurisdictional guarantee association amount.

In accordance with another aspect of the present invention, the product further comprises at least a third insurance policy, the at least a third policy having a third coverage value, the third coverage value being at least ½ of the difference between the first coverage value and the jurisdictional guarantee association amount, the at least a third policy containing a provision wherein the at least a third insurance policy only provides coverage if the admitted carrier and the insurance provider of the at least a second insurance policy become insolvent.

In accordance with another aspect of the present invention, an insurance product includes at least one insurance policy, the insurance policy containing no deductible, the insurance policy having a coverage value, the coverage value paying the amount of a claim that exceeds approximately $100,000.

In accordance with another aspect of the present invention, the coverage value pays the amount of a claim that exceeds approximately $250,000.

In accordance with another aspect of the present invention, the coverage value pays the amount of a claim that exceeds approximately $100,000 up to the amount substantially equal to approximately $100,000 plus a jurisdictional guarantee association amount.

In accordance with another aspect of the present invention, an insurance product includes at least two insurance policies having a combined coverage value, wherein approximately 50% or more of the combined coverage value is protected by a jurisdictional guarantee association, the at least two insurance policies being underwritten by at least two insurance companies, wherein at least one of the insurance companies is an admitted carrier, and at least one of the insurance companies is a non-admitted carrier, and wherein the insurance policies are layered such that the insurance policy underwritten by the admitted carrier is applied to a potential claim first.

In accordance with another aspect of the present invention, a method of providing insurance, the method includes the steps of providing a primary insurance policy, the primary insurance policy having a coverage value, the coverage value being approximately 200%, or less, of the jurisdictional guarantee association amount, wherein the primary insurance policy being provided by an admitted carrier, and providing at least one excess insurance policy, the at least one excess insurance policy having at least a second coverage value, the second coverage value being equal to a first required amount minus the coverage value of the primary insurance policy.

In accordance with another aspect of the present invention, the coverage value is approximately 150%, or less, of the jurisdictional guarantee association amount.

In accordance with another aspect of the present invention, the coverage value is approximately equal to, or less than, the jurisdictional guarantee association amount.

In accordance with another aspect of the present invention, the method further includes the step of providing excess insurance policies until the combined coverage of the primary insurance policy and the excess insurance policies is at least equal to a first required amount, wherein each excess insurance policy has an excess insurance policy coverage value that is, on average, approximately 200%, or less, of the jurisdictional guarantee association amount.

In accordance with another aspect of the present invention, the at least one excess insurance policy is provided by a second carrier

In accordance with another aspect of the present invention, the excess insurance policy coverage value is approximately 150%, or less, of the jurisdictional guarantee association amount.

In accordance with another aspect of the present invention, the excess insurance policy coverage value is approximately equal to, or less than, the jurisdictional guarantee association amount.

In accordance with another aspect of the present invention, all of the excess insurance policies are provided by an admitted carrier.

In accordance with another aspect of the present invention, an insurance product includes a primary insurance policy, the primary insurance policy having a coverage value, the value being approximately 200%, or less, of a jurisdictional guarantee association amount, the primary insurance policy being provided by an admitted carrier, and at least one excess insurance policy, the excess insurance policy having a second coverage value, the second coverage value being equal to at least a first required amount minus the coverage value of the primary insurance policy.

In accordance with another aspect of the present invention, the product further includes multiple excess insurance policies, wherein the combined coverage of the primary insurance policy and the excess insurance policies is at least equal to the first required amount, wherein each excess insurance policy has an excess insurance policy coverage value that is, on average, approximately 200%, or less, of the jurisdictional guarantee association amount.

In accordance with another aspect of the present invention, a method of providing medical malpractice insurance, the method includes the steps of providing a primary insurance policy, the primary insurance policy having a coverage value, the value being 200%, or less, of a jurisdictional guarantee association amount, the primary insurance policy being provided by an admitted carrier, providing a first excess insurance policy, the excess insurance policy having a second coverage value, the second coverage value being 200%, or less, of a jurisdictional guarantee association amount, the first excess insurance policy being provided by a second carrier, providing a second excess insurance policy, the second excess insurance policy having a third coverage value, the third coverage value being 200%, or less, of a jurisdictional guarantee association amount, the second excess insurance policy being provided by a third carrier, and providing a third excess insurance policy, the third excess insurance policy having a fourth coverage value, the fourth coverage value being equal to at least a first required amount minus the combined coverage values of the primary insurance policy, the first excess insurance policy, and the second excess insurance policy, wherein the third excess insurance policy is provided by a fourth carrier.

In accordance with another aspect of the present invention, an insurance policy includes a total coverage value, a portion of risk being covered by the insurance provider, and a deductible, the deductible being for a specified amount above the portion of risk being covered by the insurance provider.

In accordance with another aspect of the present invention, the portion of risk being covered by the insurance provider is approximately 200%, or less, of a jurisdictional guarantee association amount, the insurance policy being provided by an admitted carrier.

In accordance with another aspect of the present invention, an insurance product includes a combined coverage value, wherein approximately 50% or more of the combined coverage value is protected by a jurisdictional guarantee association.

In accordance with another aspect of the present invention, a method for providing an insurance product, wherein a jurisdictional guarantee association exists, and the association only covers claims due to the insolvency of an admitted carrier filed within a specified time period includes the steps of providing a primary insurance policy, the primary insurance policy having a coverage value, the primary insurance policy being provided by the admitted carrier and providing a second insurance policy, wherein if the admitted carrier becomes insolvent and the policyholder does not file a claim with the association within the specified time period, the second insurance policy provides a second coverage value, the second coverage value at least as much as a jurisdictional guarantee association amount, wherein the second insurance policy is provided by a second insurance provider.

Still other benefits and advantages of the invention will become apparent to those skilled in the art upon a reading and understanding of the following detailed specification.

### IV. DESCRIPTION OF THE INVENTION

Most states have guarantee funds to help pay the claims of financially impaired insurance companies. State laws specify the lines of insurance covered by these funds and the dollar limits payable. Coverage is usually for individual policyholders and their beneficiaries and not for values held in unallocated group contracts. Most states also restrict insurance agents and companies from advertising the funds' availability. Table 1 below shows the guarantee funds by state as of Aug. 31, 2004.

TABLE 1
Liability Limits

| | | | Max. | |
|---|---|---|---|---|
| | Max. | | liability | Max. |
| | aggregate | Max. death | for cash or | liability |
| | benefits | benefit with | withdrawal | for present |
| | for | respect | value of life | value of an |
| | all lines of | to any | insurance | annuity |
| State | insurance | one life | policy | contract |
| Alabama | $300,000 | $300,000 | $100,000 | $100,000 |
| Alaska | $300,000 | $300,000 | $100,000 | $100,000 |
| Arizona | $300,000 | $300,000 | $100,000 | $100,000 |
| Arkansas | $300,000 | $300,000 | $300,000 | $300,000 |
| California | 80% not | 80% not to | 80% not to | 80% not to |
| | to exceed | exceed | exceed | exceed |
| | $250,000 | $250,000 | $100,000 | $100,000 |
| Colorado | $300,000 | $300,000 | $100,000 | $100,000 |
| Connecticut | $300,000 | $300,000 | $100,000 | $100,000 |
| Delaware | $300,000 | $300,000 | $100,000 | $100,000 |
| Dist. of Col. | $300,000 | $300,000 | $100,000 | $300,000 |
| Florida | $300,000 | $300,000 | $100,000 | $100,000 |
| Georgia | $300,000 | $300,000 | $100,000 | $100,000 |
| Hawaii | $300,000 | $300,000 | $100,000 | $100,000 |
| Idaho | $300,000 | $300,000 | $100,000 | $100,000 |
| Illinois | $300,000 | $300,000 | $100,000 | $100,000 |
| Indiana | $300,000 | $300,000 | $100,000 | $100,000 |
| Iowa | $300,000 | $300,000 | $100,000 | $100,000 |
| Kansas | $300,000 | $300,000 | $100,000 | $100,000 |
| Kentucky | $300,000 | $300,000 | $100,000 | $100,000 |
| Louisiana | $300,000 | $300,000 | $100,000 | $100,000 |
| Maine | $300,000 | $300,000 | $100,000 | $100,000 |
| Maryland | $300,000 | $300,000 | $100,000 | $100,000 |
| Massachusetts | $300,000 | $300,000 | $100,000 | $100,000 |
| Michigan | $300,000 | $300,000 | $100,000 | $100,000 |
| Minnesota | $300,000 | $300,000 | $100,000 | $100,000 |
| Mississippi | $300,000 | $300,000 | $100,000 | $100,000 |
| Missouri | $300,000 | $300,000 | $100,000 | $100,000 |
| Montana | $300,000 | $300,000 | $100,000 | $100,000 |
| Nebraska | $300,000 | $300,000 | $100,000 | $100,000 |
| Nevada | $300,000 | $300,000 | $100,000 | $100,000 |
| New Hampshire | $300,000 | $300,000 | $100,000 | $100,000 |
| New Jersey | $500,000 | $500,000 | $100,000 | $100,000 |
| New Mexico | $300,000 | $300,000 | $100,000 | $100,000 |
| New York | $500,000 | $500,000 | $500,000 | $500,000 |
| No. Carolina | $300,000 | $300,000 | $300,000 | $300,000 |
| North Dakota | $300,000 | $300,000 | $100,000 | $100,000 |
| Ohio | $300,000 | $300,000 | $100,000 | $100,000 |
| Oklahoma | $300,000 | $300,000 | $100,000 | $300,000 |
| Oregon | $300,000 | $300,000 | $100,000 | $100,000 |
| Pennsylvania | $300,000 | $300,000 | $100,000 | $100,000 |
| Puerto Rico | $300,000 | $300,000 | $100,000 | $100,000 |
| Rhode Island | $300,000 | $300,000 | $100,000 | $100,000 |
| So. Carolina | $300,000 | $300,000 | $300,000 | $300,000 |
| South Dakota | $300,000 | $300,000 | $100,000 | $100,000 |
| Tennessee | $300,000 | $300,000 | $100,000 | $100,000 |
| Texas | $300,000 | $300,000 | $100,000 | $100,000 |
| Utah | $500,000 | $500,000 | $200,000 | $200,000 |
| Vermont | $300,000 | $300,000 | $100,000 | $100,000 |
| Virginia | $300,000 | $300,000 | $100,000 | $100,000 |
| Washington | $500,000 | $500,000 | $500,000 | $500,000 |
| West Virginia | $300,000 | $300,000 | $100,000 | $100,000 |
| Wisconsin | $300,000 | $300,000 | $300,000 | $300,000 |
| Wyoming | $300,000 | $300,000 | $100,000 | $100,000 |

The present invention creates a solution in which an “admitted carrier” insures the primary layer of risk up to the dollar amount covered by the appropriate guarantee association/fund (this amount varies by state). The RRG, CIC, IIE, NAI, or E&S carrier then insures the excess layer above the primary layer. This may be accomplished by constructing two policies that “follow form” in most aspects of the coverage—policies that are intended to work in tandem with each other (such as a primary policy and an excess policy). The admitted carrier offers a primary policy up to the limits of coverage that will maximize the coverage afforded by the guarantee fund in the respective jurisdiction in the event that the admitted carrier were to fail financially. The RRG, CIC, IIE, NAI, or E&S carrier would cover, through an excess policy, all amounts above the unique primary layer covered by the admitted carrier and the guarantee fund, if necessary.

In one embodiment of the invention, the combination of coverage between the admitted carrier and the excess insuring entity will provide a total combined limit of indemnity equal to at least the minimum requirements for coverage placed upon a given policyholder by a third party—such as a hospital would place upon a physician in order to maintain admitting privileges. In one embodiment of the present invention, wherein the jurisdictional guarantee association amount is $300,000, a primary policy could be issued for $300,000/$900,000, and the excess policy could be issued for $700,000/$2,100,000.

The following examples show several of the possible embodiments of this invention, but are not intended to limit the invention in any manner. Any combinations of carriers, coverage amounts, and aggregate amounts are possible, as long as the primary policy's coverage amount does not exceed approximately 200% of the jurisdictional guarantee association amount. In the following examples, the jurisdictional guarantee association amount is $300,000, and the required amount is $1,000,000/$3,000,000.

### EXAMPLE 1

Admitted carrier—$300,000/$900,000 primary policy
Non-admitted carrier (1)—$300,000/$900,000 excess policy
Non-admitted carrier (2)—$300,000/$900,000 excess policy
Non-admitted carrier (3)—$100,000/$300,000 excess policy

### EXAMPLE 2

Admitted carrier—$300,000/$900,000 primary policy
Admitted carrier (2)—$300,000/$900,000 excess policy
Non-admitted carrier—$300,000/$900,000 excess policy
Non-admitted carrier (2)—$100,000/$300,000 excess policy

### EXAMPLE 3

Admitted carrier—$300,000/$900,000 primary policy
Non-admitted carrier (1)—$300,000/$900,000 excess policy
Admitted carrier (2)—$300,000/$900,000 excess policy
Non-admitted carrier (2)—$100,000/$300,000 excess policy

### EXAMPLE 4

Admitted carrier—$300,000/$900,000 primary policy
Admitted carrier (2)—$300,000/$900,000 excess policy
Admitted carrier (3)—$300,000/$900,000 excess policy
Non-admitted carrier—$100,000/$300,000 excess policy

### EXAMPLE 5

Admitted carrier—$300,000/$900,000 primary policy
Admitted carrier (2)—$300,000/$900,000 excess policy
Non-admitted carrier—$300,000/$900,000 excess policy
Admitted carrier (3)—$100,000/$300,000 excess policy

### EXAMPLE 6

Admitted carrier—$300,000/$900,000 primary policy
Admitted carrier (2)—$300,000/$900,000 excess policy
Admitted carrier (3)—$300,000/$900,000 excess policy
Admitted carrier (4)—$100,000/$300,000 excess policy

### EXAMPLE 7

Admitted carrier—$300,000/$1,500,000 primary policy
Non-admitted carrier (1)—$300,000/$700,000 excess policy
Non-admitted carrier (2)—$300,000/$500,000 excess policy
Non-admitted carrier (3)—$100,000/$300,000 excess policy

### EXAMPLE 8

Admitted carrier—$300,000/$1,500,000 primary policy
Admitted carrier (2)—$300,000/$700,000 excess policy
Non-admitted carrier—$300,000/$500,000 excess policy
Non-admitted carrier (2)—$100,000/$300,000 excess policy

### EXAMPLE 9

Admitted carrier—$300,000/$ 1,500,000 primary policy
Non-admitted carrier (1)—$300,000/$700,000 excess policy
Admitted carrier (2)—$300,000/$500,000 excess policy
Non-admitted carrier (2)—$100,000/$300,000 excess policy

### EXAMPLE 10

Admitted carrier—$300,000/$1,500,000 primary policy
Admitted carrier (2)—$300,000/$700,000 excess policy
Admitted carrier (3)—$300,000/$500,000 excess policy
Non-admitted carrier—$100,000/$300,000 excess policy

### EXAMPLE 11

Admitted carrier—$300,000/$1,500,000 primary policy
Admitted carrier (2)—$300,000/$700,000 excess policy
Non-admitted carrier—$300,000/$500,000 excess policy
Admitted carrier (3)—$100,000/$300,000 excess policy

### EXAMPLE 12

Admitted carrier—$300,000/$1,500,000 primary policy
Admitted carrier (2)—$300,000/$700,000 excess policy
Admitted carrier (3)—$300,000/$500,000 excess policy
Admitted carrier (4)—$100,000/$300,000 excess policy

### EXAMPLE 13

Admitted carrier—$450,000/$1,000,000 primary policy
Non-admitted carrier (1)—$450,000/$1,000,000 excess policy
Non-admitted carrier (2)—$100,000/$1,000,000 excess policy

### EXAMPLE 14

Admitted carrier—$450,000/$ 1,000,000 primary policy
Admitted carrier (2)—$450,000/$1,000,000 excess policy
Non-admitted carrier—$100,000/$1,000,000 excess policy

### EXAMPLE 15

Admitted carrier—$450,000/$ 1,000,000 primary policy
Non-admitted carrier—$450,000/$1,000,000 excess policy
Admitted carrier (2)—$100,000/$1,000,000 excess policy

### EXAMPLE 16

Admitted carrier—$450,000/$ 1,000,000 primary policy
Admitted carrier (2)—$450,000/$1,000,000 excess policy
Admitted carrier (3)—$100,000/$1,000,000 excess policy

### EXAMPLE 17

Admitted carrier—$450,000/$ 1,000,000 primary policy
Admitted carrier (2)—$450,000/$1,000,000 excess policy
Non-admitted carrier—$100,000/$ 1,000,000 excess policy

### EXAMPLE 18

Admitted carrier—$450,000/$ 1,000,000 primary policy
Admitted carrier (2)—$450,000/$1,000,000 excess policy
Admitted carrier (3)—$100,000/$1,000,000 excess policy

### EXAMPLE 19

Admitted carrier—$400,000/$ 1,000,000 primary policy
Non-admitted carrier (1)—$400,000/$1,000,000 excess policy
Non-admitted carrier (2)—$200,000/$1,000,000 excess policy

### EXAMPLE 20

Admitted carrier—$400,000/$ 1,000,000 primary policy
Admitted carrier (2)—$400,000/$1,000,000 excess policy
Non-admitted carrier—$200,000/$1,000,000 excess policy

### EXAMPLE 21

Admitted carrier—$400,000/$ 1,000,000 primary policy
Non-admitted carrier (1)—$400,000/$1,000,000 excess policy
Admitted carrier (2)—$200,000/$1,000,000 excess policy

### EXAMPLE 22

Admitted carrier—$400,000/$1,000,000 primary policy
Admitted carrier (2)—$400,000/$1,000,000 excess policy
Admitted carrier (3)—$200,000/$1,000,000 excess policy

### EXAMPLE 23

Admitted carrier—$400,000/$ 1,000,000 primary policy
Admitted carrier (2)—$400,000/$ 1,000,000 excess policy
Non-admitted carrier—$200,000/$1,000,000 excess policy

### EXAMPLE 24

Admitted carrier—$400,000/$ 1,000,000 primary policy
Admitted carrier (2)—$400,000/$ 1,000,000 excess policy
Admitted carrier (3)—$200,000/$1,000,000 excess policy

In certain jurisdictions the admitted carrier would need to offer primary layer limits above the guarantee fund limits, so that the guarantee fund would respond to the full maximum amount of indemnification available from the fund. For example, if the fund provided a maximum of half of the coverage limits available under the failed admitted carrier up to a maximum of $200,000.00, then the optimum coverage point would be for the admitted carrier to indemnify the first $400,000.00 payable and for the RRG, CIC, IIE, NAI, or E&S carrier to cover the excess limits above this amount.

In establishing such an arrangement as described briefly herein, the policyholder will be afforded the “full protection” of the guarantee fund in their particular jurisdiction, while enjoying the flexibility and price benefits of insuring the excess layers of their coverage through a RRG, CIC, IIE, NAI, E&S carrier, or other alternative risk transfer vehicle. This strategy will yield benefits, flexibility, and opportunity for insurance buyers, non-admitted carriers, and even certain admitted carriers.

In another embodiment of the present invention, the primary policy would provide coverage for the first $300,000, the first excess policy would provide coverage for $300,000.01 up to and including $600,000, the second excess policy would provide coverage for $600,000.01 up to and including $900,000, and the third excess policy would provide coverage for $900,000.01 up to and including $1,000,000. Of course, it is to be understood that any combination of admitted and non-admitted carriers, as well as any combination of coverage amount is contemplated by this invention, as long as the primary policy coverage amount is less than or equal to the jurisdictional guarantee association amount.

In another embodiment of the invention, the primary policy, as well as any other policies can be up to approximately 200%, or less, of the jurisdictional guarantee association amount. In another embodiment of the invention, the primary policy, as well as any other policies can be up to approximately 150%, or less, of the jurisdictional guarantee association amount. In another embodiment of the invention, the primary policy, as well as any other policies can be up to approximately 100%, or less, of the jurisdictional guarantee association amount. It is to be understood, however, that the policies can be, but is not limited to, any of the following percentages of the jurisdictional guarantee association amount: 100, 101, 102, 103, 104, 105, 106, 107, 108, 109, 110, 111, 112, 113, 114, 115, 116, 117, 118, 119, 120, 121, 122, 123, 124, 125, 126, 127, 128, 129, 130, 131, 132, 133, 134, 135, 136, 137, 138, 139, 140, 141, 142, 143, 144, 145, 146, 147, 148, 149, 150, 151, 152, 153, 154, 155, 156, 157, 158, 159, 160, 161, 162, 163, 164, 165, 166, 167, 168, 169, 170, 171, 172, 173, 174, 175, 176, 177, 178, 179, 180, 181, 182, 183, 184, 185, 186, 187, 188, 189, 190, 191, 192, 193, 194, 195, 196, 197, 198, 199, and 200.

In another embodiment of the invention, an insurance product has a combined coverage value, wherein approximately 50% or more of the combined coverage value is protected by a jurisdictional guarantee association. In another embodiment of the invention, approximately ⅔ or more of the combined coverage value is protected by a jurisdictional guarantee association. In another embodiment of the invention, approximately 75% or more of the combined coverage value is protected by a jurisdictional guarantee association. In another embodiment of the invention, approximately 90% or more of the combined coverage value is protected by a jurisdictional guarantee association. In another embodiment of the invention, approximately 100% or more of the combined coverage value is protected by a jurisdictional guarantee association. It is to be understood, however, that the percentage of the combined coverage value protected by the jurisdictional guarantee association can be, but is not limited to, any of the following percentages: 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, and 100.

It is to be understood that the above embodiments of the invention are related to situations where the policyholder is required to have a particular amount of insurance. For example, in Ohio, physicians are generally required by hospitals to carry insurance in the amount $1,000,000 coverage amount, with an aggregate amount of $3,000,000. Of course it is to be understood that the jurisdictional guarantee association amount, the average coverage for policyholders, as well as the required amounts by hospitals, or other third parties, could change with time, and this invention is intended to cover those potential changes. This particular embodiment of the invention is intended to provide a total coverage up to the amount required by a third party, which in one particular embodiment is a hospital.

In another embodiment of this invention, the insurance policy could be a homeowner's insurance policy. For example, if a home is valued at $1,000,000, a $1,000,000 insurance policy may only be guaranteed up to $300,000. Therefore, in one embodiment of this invention, a primary policy would be provided in the amount of $300,000, two excess policies would be provided in the amount of $300,000 each, and a third excess policy would be provided in the amount of $ 100,000.

Although the various embodiments above have mentioned homeowner's and medical malpractice insurance, it is to be understood that this invention encompasses any type of insurance policy, except for life insurance.

In another embodiment of this invention, someone other than the policyholder or the insurance provider would coordinate and manage the various policies. The third party would coordinate aspects of the process such as underwriting, marketing, compliance with state regulatory agencies, accounting, as well as other areas of the process. This coordination could take the form of ensuring that the policies do not contain conflicting information, and that the policyholder's interests are adequately protected.

It is to be understood that the invention as described above could be implemented using computer or electronic equipment, such that the various policies could be written or prepared via a computer readable medium. Also, it is to be understood that in one embodiment of this invention, the policies could be automatically updated if the jurisdictional guarantee association amount or the required amount changes.

In another embodiment of this invention, the deductible for the insurance policy is placed in the middle or at the top end of the policy. For example, if the insurance policy is written for $600,000, with a deductible of $300,000, the deductible would be payable by the policyholder only after the first $300,000 was paid by the insurance provider. This embodiment of the invention allows the policyholder to take full advantage of the jurisdictional guarantee association amount. Another example would be a $1,000,000 policy with a $300,000 deductible, wherein the deductible is payable by the policyholder only after the first $300,000 is paid by the insurance provider. In this example, if a judgment was given for $800,000, the insurance provider would pay the first $300,000, the policyholder would pay the next $300,000, and the insurance provider would pay the final $200,000. This embodiment can be combined with the previous embodiments regarding the jurisdictional guarantee association amount.

In another embodiment of the invention, an insurance product is underwritten on a quota share basis. At least two insurance policies are underwritten, wherein the policies have a combined coverage value, the percentage of the combined coverage value covered by each policy being about equal. For example, in a situation where $ 1,000,000 coverage is required, two policies are written, wherein each policy will be 50% of the total amount of a claim, no matter what the claim amount is. For example, a physician has an insurance product that consists of two insurance policies, which are underwritten on a 50/50 quota share basis, and a coverage per claim of $1,000,000. If that physician is sued for malpractice, and an award of $700,000 is given by the court, the first insurance policy would pay $350,000 and the second insurance policy would pay $350,000. It is to be understood that the percentages divided between the different policies can be any percentage chosen using sound business judgment. For example, the split could be 25/75, or there could be three policies, split on a quota share basis of ⅓/⅓/⅓. It is also to be understood that the percentages of the quota share can be, but is not limited to, any of the following percentages: 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, and 99. It is also to be understood that the embodiments of this invention that deal with the jurisdictional guarantee association amount can be combined with the quota share embodiment.

In another embodiment of the invention, the issue of consolidation of claims is dealt with. The Ohio Supreme Court, in Katz v. OIGA, held that a medical doctor and a professional liability insurer may agree that the insurer's liability for all damages sustained from the death of one person is subject to the monetary limit declared for each “claim,” irrespective of the number of wrongful death claimants. In this embodiment of the invention, an insurance product contains multiple insurance policies, and consolidation is allowed within each policy, but not between the individual policies.

Each insurance jurisdiction in the United States has guarantee association that protects the policyholder in the event that their insurance provider becomes insolvent. For example, in Ohio, the Ohio Insurance Guarantee Association will cover up to $300,000 of an insurance policy if the insurance provider becomes insolvent. However, most of the associations require that a claim be filed within a certain time period. For example, a claim may have to be filed within twelve months of the insurance provider becoming insolvent. Therefore, if a claim is filed with the association after the specified time period, the association will not provide protection for the policyholder. In one embodiment of this invention, a policy is provided that will cover the policyholder if the policyholder does not file a claim with the association on time. For example, if the association requires a claim to filed within twelve months, and the policyholder does not file until fourteen months after the insurance provider becomes insolvent, the present invention provides a policy that will indemnify the policyholder for the amount of the failed policy. In this embodiment of the invention, the second policy is provided by an insurance provider other than the insurance provider that became insolvent.

The invention has been described with reference to several embodiments. Obviously, modifications and alterations will occur to others upon a reading and understanding of the specification. It is intended by applicant to include all such modifications and alterations insofar as they come within the scope of the appended claims or the equivalents thereof. The use of terms first, second, third, etc. are not necessarily intended to denote numerical or chronological order.

Having thus described the invention, it is now claimed:

1. An insurance product comprising:
at least two primary insurance policies written on a quota share basis, the policies having a combined coverage value, the percentage of the combined coverage value covered by each policy being between about 1% and about 99%.

2. The product of claim 1, wherein the percentage of the coverage value covered by each policy being between about 25% and about 75%.

3. The product of claim 2, wherein the percentage of the coverage value covered by each policy is substantially equal.

4. The product of claim 1, wherein the at least two insurance policies are underwritten by at least two insurance companies.

5. The product of claim 4, wherein at least one of the at least two insurance companies are admitted carriers.

6. The product of claim 1, wherein the insurance product is chosen from the group comprising: a property insurance policy, a casualty insurance policy, a health insurance policy, a workers compensation insurance policy, and a disability insurance policy.

7. The product of claim 1, wherein the at least two primary insurance policies further comprises at least three primary insurance policies.

8. The product of claim 7, wherein the at least three primary insurance policies are underwritten by at least three insurance companies.

9. The product of claim 8, wherein at least two of the at least three insurance companies are admitted carriers.

10. The product of claim 9, wherein only the first of the admitted carriers to become insolvent would be covered by a jurisdictional guarantee association.

11. The product of claim 1, wherein approximately 50% or more of the combined coverage value is protected by a jurisdictional guarantee association.

12. The product of claim 11, wherein the insurance product is underwritten by an admitted carrier.

13. The product of claim 12, wherein the insurance product comprises at least two insurance policies.

14. The product of claim 13, wherein the insurance product is underwritten by at least two insurance companies, wherein at least one of the at least two insurance companies are admitted carriers.

15. The product of claim 11, wherein the insurance product is chosen from the group comprising: a property insurance policy, a casualty insurance policy, a health insurance policy, a workers compensation insurance policy, and a disability insurance policy.

16. The product of claim 11, wherein approximately ⅔ or more of the combined coverage value is protected by a jurisdictional guarantee association.

17. The product of claim 16, wherein approximately 75% or more of the combined coverage value is protected by a jurisdictional guarantee association.

18. The product of claim 17, wherein approximately 90% or more of the combined coverage value is protected by a jurisdictional guarantee association.

19. The product of claim 13, wherein the insurance product comprises at least three insurance policies.

20. The product of claim 13, wherein the product further comprises a provision wherein a claim is treated as distinct and separate for each insurance policy.

21. The product of claim 13, wherein the product further comprises a provision wherein claims may be consolidated within one of the policies, but may not be consolidated between multiple policies.

22. The product of claim 19, wherein the product further comprises a provision wherein a claim is treated as distinct and separate for each insurance policy.

23. The product of claim 19, wherein the product further comprises a provision wherein claims may be consolidated within one of the policies, but may not be consolidated between multiple policies.

24. The product of claim 11, wherein the jurisdictional guarantee association amount coverage is approximately 50% or more of the mode of current policy amounts for all insureds in a given line of insurance within a given insurance jurisdiction.

25. The product of claim 11, wherein the jurisdictional guarantee association amount coverage is approximately 50% or more of the median of current policy amounts for all insureds in a given line of insurance within a given insurance jurisdiction.

26. The product of claim 11, wherein the jurisdictional guarantee association amount coverage is approximately 50% or more of the average of current policy amounts for all insureds in a given line of insurance within a given insurance jurisdiction.

27. The product of claim 1, wherein the insurance product has no reinsurance backing.

28. The product of claim 27, wherein the reinsurance backing is approximately 10% or less of coverage value.

29. The product of claim 28, wherein the reinsurance backing is approximately 50% or less of coverage value.

30. A method of providing insurance, the method comprising the steps of:
providing an insurance product having a combined coverage value, wherein approximately 50% or more of the combined coverage value is protected by a jurisdictional guarantee association.

31. The method of claim 30, wherein the insurance product is underwritten by an admitted carrier.

32. The method of claim 30, wherein the insurance product comprises at least two insurance policies.

33. The method of claim 32, wherein the insurance product is underwritten by at least two insurance companies, wherein at least one of the at least two insurance companies are admitted carriers.

34. The method of claim 30, wherein the insurance product is chosen from the group comprising: a property insurance policy, a casualty insurance policy, a health insurance policy, a workers compensation insurance policy, and a disability insurance policy.

35. The method of claim 30, wherein approximately ⅔ or more of the combined coverage value is protected by a jurisdictional guarantee association.

36. The method of claim 35, wherein approximately 75% or more of the combined coverage value is protected by a jurisdictional guarantee association.

37. The method of claim 36, wherein approximately 90% or more of the combined coverage value is protected by a jurisdictional guarantee association.

38. The method of claim 32, wherein the insurance product comprises at least three insurance policies.

39. The method of claim 32, wherein the product further comprises a provision wherein a claim is treated as distinct and separate for each insurance policy.

40. The method of claim 32, wherein the product further comprises a provision wherein claims may be consolidated within one of the policies, but may not be consolidated between multiple policies.

41. The method of claim 30, wherein the product comprises at least two primary insurance policies, the at least two primary insurance policies being written on a quota share basis, the policies having a combined coverage value, the percentage of the combined coverage value covered by each policy being between about 1% and about 99%.

42. The method of claim 41, wherein the percentage of the coverage value covered by each policy being between about 25% and about 75%.

43. The method of claim 42, wherein the percentage of the coverage value covered by each policy is substantially equal.

44. The method of claim 41, wherein the at least two insurance policies are underwritten by at least two insurance companies.

45. The method of claim 41, wherein the at least two insurance policies is at least three insurance policies, and the at least three insurance policies are underwritten by at least three insurance companies.

46. The method of claim 45, wherein at least one of the at least two insurance companies are admitted carriers.

47. The method of claim 41, wherein the insurance product is chosen from the group comprising: a property insurance policy, a casualty insurance policy, a health insurance policy, a workers compensation insurance policy, and a disability insurance policy.

48. The method of claim 41, wherein the at least two primary insurance policies further comprises at least three primary insurance policies.

49. The method of claim 48, wherein at least two of the at least three insurance companies are admitted carriers.

50. The method of claim 49, wherein only the first of the admitted carriers to become insolvent would be covered by a jurisdictional guarantee association.

51. The method of claim 44, wherein the method further comprises the step of:
providing coordinated claims management by one chosen from the group comprising: one of the at least two insurance companies and a managing general underwriter.

52. The method of claim 44, wherein the method further comprises the step of:
providing coordinated underwriting by one chosen from the group comprising:
one of the at least two insurance companies and a third party administrator.

53. The method of claim 30, wherein the jurisdictional guarantee association amount of coverage is approximately 50% or more of the mode of current policy amounts for all insureds in a given line of insurance within a given insurance jurisdiction.

54. The method of claim 30, wherein the jurisdictional guarantee association amount of coverage is approximately 50% or more of the median of current policy amounts for all insureds in a given line of insurance within a given insurance jurisdiction.

55. The product of claim 30, wherein the jurisdictional guarantee association amount of coverage is approximately 50% or more of the average of current policy amounts for all insureds in a given line of insurance within a given insurance jurisdiction.

56. The method of claim 30, wherein the insurance product has no reinsurance backing.

57. The method of claim 56, wherein the reinsurance backing is approximately 10% or less of coverage value.

58. The method of claim 57, wherein the reinsurance backing is approximately 50% or less of coverage value.

59. The method of claim 33, wherein the method further comprises the step of:
switching management of at least one claim to another of the carriers if the carrier managing the at least one claim becomes insolvent.

60. An insurance product for insuring against failure of an admitted carrier, wherein the admitted carrier has provided a first insurance policy with a first coverage value greater than a jurisdictional guarantee association amount, the product comprising:
at least a second insurance policy, the at least a second policy having a second coverage value, the second coverage value being at least ½ of the difference between the first coverage value and the jurisdictional guarantee association amount, the at least a second policy containing a provision wherein the at least a second insurance policy only provides coverage if the admitted carrier becomes insolvent.

61. The product of claim 60, wherein the second coverage value is at least ⅔ of the difference between the first coverage value and the jurisdictional guarantee association amount.

62. The product of claim 61, wherein the second coverage value is at least the difference between the first coverage value and the jurisdictional guarantee association amount.

63. The product of claim 60, wherein the at least a second insurance policy is underwritten by an admitted carrier.

64. The product of claim 63, wherein the at least a second insurance policy further comprises at least a second and third insurance policies, wherein the at least a second and third insurance policies have a combined coverage value, the combined coverage value being at least ½ of the difference between the first coverage value and the jurisdictional guarantee association amount.

65. The product of claim 60, wherein the product further comprises:
at least a third insurance policy, the at least a third policy having a third coverage value, the third coverage value being at least ½ of the difference between the first coverage value and the jurisdictional guarantee association amount, the at least a third policy containing a provision wherein the at least a third insurance policy only provides coverage if the admitted carrier and the insurance provider of the at least a second insurance policy become insolvent.

66. The product of claim 60, wherein the insurance product is chosen from the group comprising: a property insurance policy, a casualty insurance policy, a health insurance policy, a workers compensation insurance policy, and a disability insurance policy.

67. An insurance product comprising:
at least one insurance policy, the insurance policy containing no deductible, the insurance policy having a coverage value, the coverage value paying the amount of a claim that exceeds approximately $100,000.

68. The insurance product of claim 67, wherein the coverage value pays the amount of a claim that exceeds approximately $250,000.

69. The insurance product of claim 67, wherein the coverage value pays the amount of a claim that exceeds approximately $ 100,000 up to the amount substantially equal to approximately $100,000 plus a jurisdictional guarantee association amount.

70. The insurance product of claim 69, wherein the insurance product is underwritten by an admitted carrier.

71. An insurance product comprising:
at least two insurance policies having a combined coverage value, wherein approximately 50% or more of the combined coverage value is protected by a jurisdictional guarantee association;
the at least two insurance policies being underwritten by at least two insurance companies;
wherein at least one of the insurance companies is an admitted carrier, and at least one of the insurance companies is a non-admitted carrier; and,
wherein the insurance policies are layered such that the insurance policy underwritten by the admitted carrier is applied to a potential claim first.

72. The product of claim 71, wherein the insurance product is chosen from the group comprising: a property insurance policy, a casualty insurance policy, a health insurance policy, a workers compensation insurance policy, and a disability insurance policy.

73. The product of claim 71, wherein approximately ⅔ or more of the combined coverage value is protected by a jurisdictional guarantee association.

74. The product of claim 73, wherein approximately 75% or more of the combined coverage value is protected by a jurisdictional guarantee association.

75. The product of claim 74, wherein approximately 90% or more of the combined coverage value is protected by a jurisdictional guarantee association.

76. The product of claim 71, wherein the insurance product comprises at least three insurance policies.

77. A method of providing insurance, the method comprising the steps of:
providing a primary insurance policy, the primary insurance policy having a coverage value, the coverage value being approximately 200%, or less, of the jurisdictional guarantee association amount, wherein the primary insurance policy being provided by an admitted carrier; and,
providing at least one excess insurance policy, the at least one excess insurance policy having at least a second coverage value, the second coverage value being equal to a first required amount minus the coverage value of the primary insurance policy.

78. The method of claim 77, wherein the coverage value is approximately 150%, or less, of the jurisdictional guarantee association amount.

79. The method of claim 78, wherein the coverage value is approximately equal to, or less than, the jurisdictional guarantee association amount.

80. The method of claim 77, wherein the method further comprises the step of:
providing excess insurance policies until the combined coverage of the primary insurance policy and the excess insurance policies is at least equal to a first required amount, wherein each excess insurance policy has an excess insurance policy coverage value that is, on average, approximately 200%, or less, of the jurisdictional guarantee association amount.

81. The method of claim 79, wherein the at least one excess insurance policy is provided by a second carrier

82. The method of claim 81, wherein the excess insurance policy coverage value is approximately 150%, or less, of the jurisdictional guarantee association amount.

83. The method of claim 82, wherein the excess insurance policy coverage value is approximately equal to, or less than, the jurisdictional guarantee association amount.

84. The method of claim 80, wherein all of the excess insurance policies are provided by an admitted carrier.

85. The method of claim 77, wherein the insurance policies are chosen from the group comprising: a property insurance policy, a casualty insurance policy, a health insurance policy, a workers compensation insurance policy, and a disability insurance policy.

86. An insurance product, the product comprising:
a primary insurance policy, the primary insurance policy having a coverage value, the value being approximately 200%, or less, of a jurisdictional guarantee association amount, the primary insurance policy being provided by an admitted carrier; and,
at least one excess insurance policy, the excess insurance policy having a second coverage value, the second coverage value being equal to at least a first required amount minus the coverage value of the primary insurance policy.

87. The insurance product of claim 86, wherein the product further comprises:
multiple excess insurance policies, wherein the combined coverage of the primary insurance policy and the excess insurance policies is at least equal to the first required amount, wherein each excess insurance policy has an excess insurance policy coverage value that is, on average, approximately 200%, or less, of the jurisdictional guarantee association amount.

88. The product of claim 87, wherein at least one of the excess insurance policies is provided by an admitted carrier.

89. The product of claim 88, wherein all of the excess insurance policies are provided by an admitted carrier.

90. A method of providing medical malpractice insurance, the method comprising the steps of:
providing a primary insurance policy, the primary insurance policy having a coverage value, the value being 200%, or less, of a jurisdictional guarantee association amount, the primary insurance policy being provided by an admitted carrier;
providing a first excess insurance policy, the excess insurance policy having a second coverage value, the second coverage value being 200%, or less, of a jurisdictional guarantee association amount, the first excess insurance policy being provided by a second carrier;
providing a second excess insurance policy, the second excess insurance policy having a third coverage value, the third coverage value being 200%, or less, of a jurisdictional guarantee association amount, the second excess insurance policy being provided by a third carrier; and,
providing a third excess insurance policy, the third excess insurance policy having a fourth coverage value, the fourth coverage value being equal to at least a first required amount minus the combined coverage values of the primary insurance policy, the first excess insurance policy, and the second excess insurance policy, wherein the third excess insurance policy is provided by a fourth carrier.

91. The method of claim 90, wherein at least one of the excess insurance policies is provided by an admitted carrier.

92. The method of claim 91, wherein all of the excess insurance policies are provided by an admitted carrier.

93. An insurance policy comprising:
a total coverage value;
a portion of risk being covered by the insurance provider; and,
a deductible, the deductible being for a specified amount above the portion of risk being covered by the insurance provider.

94. The insurance policy of claim 93, wherein the portion of risk being covered by the insurance provider is approximately 200%, or less, of a jurisdictional guarantee association amount, the insurance policy being provided by an admitted carrier.

95. An insurance product comprising:
a combined coverage value, wherein approximately 50% or more of the combined coverage value is protected by a jurisdictional guarantee association.

96. The product of claim 95, wherein the insurance product is underwritten by an admitted carrier.

97. The product of claim 95, wherein the insurance product comprises at least two insurance policies.

98. The product of claim 97, wherein the insurance product is underwritten by at least two insurance companies, wherein at least one of the at least two insurance companies are admitted carriers.

99. The product of claim 95, wherein the insurance product is chosen from the group comprising: a property insurance policy, a casualty insurance policy, a health insurance policy, a workers compensation insurance policy, and a disability insurance policy.

100. The product of claim 95, wherein approximately 2/3 or more of the combined coverage value is protected by a jurisdictional guarantee association.

101. The product of claim 100, wherein approximately 75% or more of the combined coverage value is protected by a jurisdictional guarantee association.

102. The product of claim 101, wherein approximately 90% or more of the combined coverage value is protected by a jurisdictional guarantee association.

103. The product of claim 97, wherein the insurance product comprises at least three insurance policies.

104. The product of claim 97, wherein the product further comprises a provision wherein a claim is treated as distinct and separate for each insurance policy.

105. The product of claim 97, wherein the product further comprises a provision wherein claims may be consolidated within one of the policies, but may not be consolidated between multiple policies.

106. The product of claim 95, wherein the product comprises at least two primary insurance policies, the at least two primary insurance policies being written on a quota share basis, the policies having a combined coverage value, the percentage of the combined coverage value covered by each policy being between about 1% and about 99%.

107. The product of claim 106, wherein the percentage of the coverage value covered by each policy being between about 25% and about 75%.

108. The product of claim 107, wherein the percentage of the coverage value covered by each policy is substantially equal.

109. The product of claim 106, wherein the at least two insurance policies are underwritten by at least two insurance companies.

110. The product of claim 106, wherein the at least two insurance policies is at least three insurance policies, and the at least three insurance policies are underwritten by at least three insurance companies.

111. The product of claim 110, wherein at least one of the at least two insurance companies are admitted carriers.

112. The product of claim 106, wherein the insurance product is chosen from the group comprising: a property insurance policy, a casualty insurance policy, a health insurance policy, a workers compensation insurance policy, and a disability insurance policy.

113. The product of claim 106, wherein the at least two primary insurance policies further comprises at least three primary insurance policies.

114. The product of claim 113, wherein at least two of the at least three insurance companies are admitted carriers.

115. The product of claim 114, wherein only the first of the admitted carriers to become insolvent would be covered by a jurisdictional guarantee association.

116. The product of claim 109, wherein the product further comprises:
coordinated claims management by one chosen from the group comprising: one of the at least two insurance companies and a managing general underwriter.

117. The product of claim 109, wherein the product further comprises:
coordinated underwriting by one chosen from the group comprising: one of the at least two insurance companies and a managing general underwriter.

118. The product of claim 95, wherein the jurisdictional guarantee association amount of coverage is approximately 50% or more of the mode of current policy amounts for all insureds in a given line of insurance within a given insurance jurisdiction.

119. The product of claim 95, wherein the jurisdictional guarantee association amount of coverage is approximately 50% or more of the median of current policy amounts for all insureds in a given line of insurance within a given insurance jurisdiction.

120. The product of claim 95, wherein the jurisdictional guarantee association amount of coverage is approximately 50% or more of the average of current policy amounts for all insureds in a given line of insurance within a given insurance jurisdiction.

121. The product of claim 95, wherein the insurance product has no reinsurance backing.

122. The product of claim 121, wherein the reinsurance backing is approximately 10% or less of coverage value.

123. The product of claim 122, wherein the reinsurance backing is approximately 50% or less of coverage value.

124. The product of claim 98, wherein the product further comprises:
a provision for switching management of at least one claim to another of the carriers if the carrier managing the at least one claim becomes insolvent.

125. A method for providing an insurance product, wherein a jurisdictional guarantee association exists, and the association only covers claims, due to the insolvency of an admitted carrier, filed within a specified time period, the method comprising the steps of:
providing a primary insurance policy, the primary insurance policy having a coverage value, the primary insurance policy being provided by the admitted carrier; and,
providing a second insurance policy, wherein if the admitted carrier becomes insolvent and the policyholder does not file a claim with the association within the specified time period, the second insurance policy provides a second coverage value, the second coverage value at least as much as a jurisdictional guarantee association amount, wherein the second insurance policy is provided by a second insurance provider.
